(19) United States
(12) Patent Application Publication
(10) Pub. No.: US 2010/0162870 A1
(43) Pub. Date: Jul. 1, 2010

(54) Machine for Creating Grout Lines on Boards and/or for Cutting Tiles from Boards and Corresponding Methods

(76) Inventor: Leif Kare Hindersland, Lygndal (NO)

Correspondence Address: DAVID I. ROCHE;BAKER & MCKENZIE LLP, 130 EAST RANDOLPH DRIVE, CHICAGO, IL, 60601, US

(21) Appl. No.: 12/604,730

(22) Filed: Oct. 23, 2009

Related U.S. Application Data
(62) Division of application No. 11/525,591, filed on Sep. 22, 2006.

(30) Foreign Application Priority Data
Sep. 27, 2005 (EP) EP 05021037.6

(51) Int. Cl. B26D 3/06; B26D 1/18

(52) U.S. Cl. 83/876; 83/875; 83/422; 83/471.2

(57) ABSTRACT

The invention includes a feeder, a support surface and a sawing device. The sawing device is moveably arranged with respect to the support surface, to reduce the probability of creating scratches on the board surfaces.

### CROSS-REFERENCE TO COPENDING APPLICATIONS

This is a divisional of co-pending U.S. patent application Ser. No. 11/525,591, filed Sep. 22, 2006, which is incorporated herein by reference.

### BACKGROUND OF THE INVENTION

The invention relates to a machine for creating grout lines on boards and/or for cutting floor panels or tiles from boards comprising a feeding means for moving a board into and/or out of the machine, a support surface for supporting the board and a sawing device comprising at least one saw, in particular at least one circular saw. The invention furthermore relates to a method for creating grout lines on boards using a machine comprising a sawing device and a method for cutting boards into floor panels or tiles, in particular floor tiles, wall tiles or bathroom tiles, using a machine comprising a sawing device.

Floor panels, wall tiles or bathroom tiles made out of boards comprise a decorative layer which has a decorative pattern to give the floor panels, wall tiles or bathroom tiles the desired decorative effect. The decorative pattern can be a wood structure, a stone structure or the like. The decorative layer is supported by a support layer thereby forming a laminate.

In case of floor tiles, wall tiles or bathroom tiles, the floor or wall covering has no continuous surface in contrast to a parquet flooring, as the groove between those tiles, like with original floor tiles or stone, is filled with a particular material, like a sealing material.

The above-described products are fabricated by cutting large boards, e.g. of wood, HDF (high density fiber) or MDF (medium density fiber) and serving as a carrier and which are covered by a decorative layer or laminate, into floor panels and tiles of a desired size using a sawing device. In addition, in the case of tiles, grout lines are created on the boards, which consist in cutting only partially into the board, without cutting through it, such that at least the decorative layer is removed, so that the support layer becomes visible and hence a particular optical effect can be achieved corresponding to grout lines between real tiles.

To do so, large boards are cut using a fixed sawing device through which the boards are moved. As the boards need to be pressed against the saw to create clear cut or grout lines, the surface of the board risks heavily in the creation of scratches in case of small particles or chips, created due to the sawing, are present on the surface being pressed against the sawing device. In addition, also on the backside, scratches can occur due to the presence of small particles or chips between the backside surface of the board and the feeding device on which the board is transported. The presence of scratches reduces the quality of the final product or leads to products that have to be rejected, thereby lowering the production yield.

### BRIEF SUMMARY OF THE INVENTION

It is therefore the object of the present invention to provide a machine for creating grout lines on panels and/or for cutting floor panels or tiles from boards with which an improved production yield and/or improved product quality can be achieved by reducing the risk of creation of scratches. It is also an object of the present invention to provide a method for improving production yield and/or product quality by reducing the risk of creation of scratches.

This problem is solved by the machine for creating grout lines on boards and/or for cutting tiles or floor panels from boards according to claim 1, the method for creating grout lines on boards according to claim 8 and/or the method for cutting boards into floor panels or tiles, in particular wall tiles or bathroom tiles according to claim 9.

According to the invention, not the boards are moved with respect to a fixed sawing device, but the sawing device which is movable and thus moves over a board, which during the cutting action is fixed, to create grout lines and/or to cut the board into floor panels or tiles.

During the movement of the saw over the board surface, the backside of the board is not moving, so that even if a pressure is applied between the sawing device and the board the probability for creating scratches on the backside is reduced. Also on the surface side towards the sawing the device and which usually carries the decorative layer, a reduced amount of scratches is observed compared to the prior art machine and/or method. This can be further improved by configuring the sawing device such that the only interaction between the sawing device and the board occurs between the sawing blade of the at least one saw and the surface of the board. Furthermore, due to fact that the board itself is stationary the occurrence of vibrations of the board is further reduced, thereby improving the accuracy of the cut performed by the sawing device.

Preferably, at least one saw can be provided on a moveable carriage. By mounting a standard saw on the moveable carriage, a simple technical realization of the sawing device can be achieved.

It might also be advantageous that the sawing device comprises two or more saws having their sawing plates preferably arranged in parallel and being provided on the moveable carriage. Thus several cut or grout lines can be realized at a time by only providing one moveable carriage.

The machine can furthermore preferably comprise a displacement means configured to move a board from the feeding means onto the support surface and/or from the support surface onto the feeding means or configured to move the sawing device towards the support surface or the feeding means. The feeding means which receives boards from an outside delivery means, for example a transportation belt etc., in a plane which is different to the plane in which the sawing device is positioned. The displacement means therefore serves to change over from one plane into the other, to bring the board into contact with the sawing blade(s) of the sawing device. After cutting the changeover of planes goes in the opposite direction and the treated board is fed out of the machine by again using the feeding device. The treated board is then either moved back onto the transportation belt or on a second transportation means, e.g. on the opposite side of the machine.

According to a preferred embodiment, the machine can furthermore comprise a means for pressing the board against the sawing device. By pressing the board against the sawing device, cuts with little fabrication tolerances can be achieved as vibrations of the board during cutting can be prevented.

In a preferred embodiment the displacement means and the means for pressing the board against the sawing device are combined into one device. This further simplifies the design of the machine as the number of elements can be reduced. An integration of the displacements means and the means of pressing into one device is furthermore simplified in case the direction of movement for changeover of the planes and pressing of the board again the saw is the same.

Advantageously the machine can furthermore comprise an adjustment means for positioning a board on the support surface or the feeding means relative to the at least one saw. Such an adjustment means further helps for improving the fabrication tolerances and/or can be used to change the position of the cut or grout lines on the board. The adjustment means is in particular configured to move the board in the plane of the board which is generally perpendicular to the plane of the sawing blade(s).

Preferably according to the inventive method, the sawing device can comprise at least two saws having sawing plates being arranged in parallel with respect to each other to thereby form at least two parallel grout lines or at least two parallel cut lines over the board. Thus several cut or grout lines can be realized at a time by only providing one moveable carriage.

According to a preferred embodiment of the inventive method the board can be pressed against the sawing device during moving of the sawing device. This serves to improve the fabrication tolerances.

Advantageously prior to step c) the board can be positioned on the support surface relative to the at least one saw. This further improves the fabrication tolerances and/or can be used to change the position of the grout lines or cut lines on the board. The adjustment of the board is preferably performed the plane of the board which is generally perpendicular to the plane of the sawing blade(s).

### BRIEF DESCRIPTION OF THE DRAWINGS

Advantageous embodiments of the invention will be illustrated and described with respect to the enclosed figures. Accordingly

FIG. 1 shows a three-dimensional view of a first embodiment of the machine for creating grout lines or cut lines according to the invention together with two transportation means not being part of the machine,

FIGS. 2a to 2f schematically illustrate the machine and the method according to the invention, and

FIG. 3 illustrates a cross-sectional view of a board which has passed through the machine according to the invention comprising grout lines, and

### DETAILED DESCRIPTION OF THE DRAWINGS

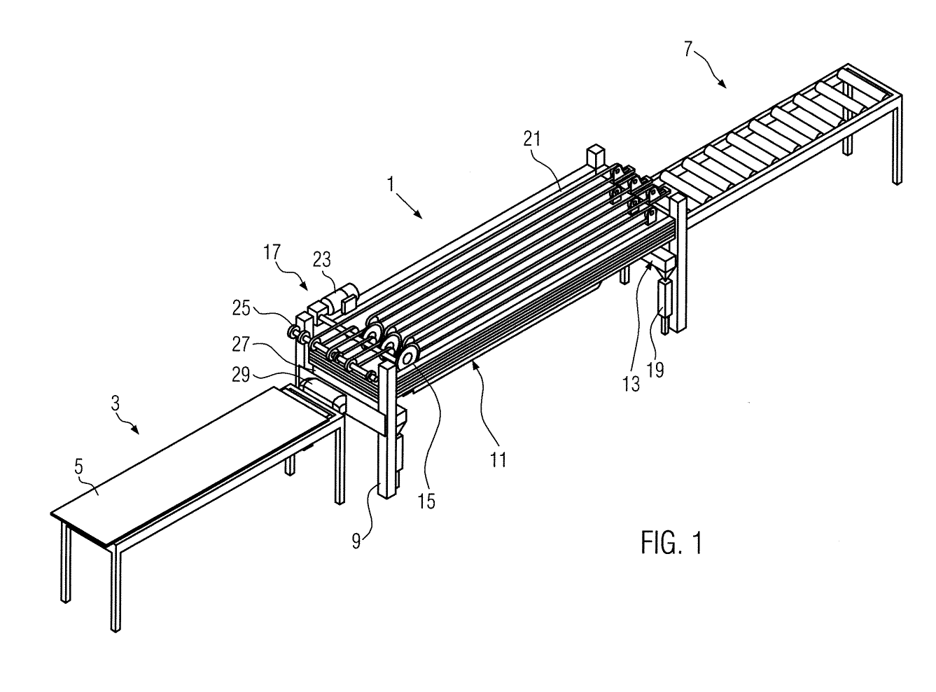

FIG. 1 is a three-dimensional view of a first embodiment of the inventive machine 1 for creating grout lines on boards and/or for cutting floor panels or tiles from boards together with, on the left side, a first transportation belt 3 used to deliver a board 5 to the machine 1 and, on the right side thereof, a second transportation belt 7. The way the transportation belts 3 and 7 are provided with respect to the machine 1 are not restrictive, as actually a transportation belt could also be provided on the longer side of the machine 1 or only one one transportation belt, instead of two, could be used.

The board 5 which is fed to the machine 1 can be a laminate structure comprising a carrier which is made of HDF, MDF, cardboard, wood plastic, metal or the like with a decorative laminate on top of it. The decorative laminate may comprise a decorative layer on a support layer. Instead of a laminate structure, the board 5 fed to the machine 1 can also be a solid wood, HDF or MDF board without a decorative laminate. A typical size of board 5 is of the order of 2,440 mm by 600 mm, so that the machine 1 is adapted to boards of this size. Of course the machine 1 could also be adapted to boards of any different size.

The machine 1 for creating grout lines on board 5 and/or for cutting floor panels or tiles from board 5 comprises a main frame 9 positioned on the floor and on which are provided the further elements of the machine 1. The machine 1 comprises a feeding means 11 which is used for receiving board 5 from the first transportation means 3 and which also serves to move board 5 out of the machine 1 onto the second transportation belt 7. To move the board 5 the feeding means 11 can be designed to have a transportation means, like a transportation belt or a plurality of moving cylinders.

The machine 1 furthermore comprises a support surface 13 which serves as support for the board 5 when the saws 15, here three saws, of the sawing device 17 move over the board 5. The support surface 13 can be moved in the vertical direction by a displacement means, here a levering device 19, provided with the pedestal of the frame 9.

The sawing device 17 with, in this embodiment, three circular saws 15 furthermore comprises a moveable carriage, which is driven by a linear drive 21. A motor 23 is used to drive a shaft 25, which in turn drives the belt of the linear drive 21. In this embodiment a linear drive is provided for each circular saw. However, without departing from the invention, the sawing device 17 could be realized with a moveable carriage having only one linear drive for more than one saw. In the embodiment of FIG. 1, the three saws 15 are at equal distance, however, each saw could be arranged such that its position with respect to the other ones could be changed such that the distance between grout lines or cut lines on the board 5 can be adapted individually.

FIG. 1 furthermore illustrates an entrance slit 27 via which board 5 can be introduced into the machine 1 and a further motor 29 to drive the circular saws.

According to a variant, the machine 1 can furthermore comprise an adjustment means (not shown) for positioning the board 5 either on the feeding means 11 or on the support surface 13 to position the board 5 in the plane perpendicular to the sawing blades. By doing so, the creation of the grout or cut lines in the board 5 are carried out at the correct positions.

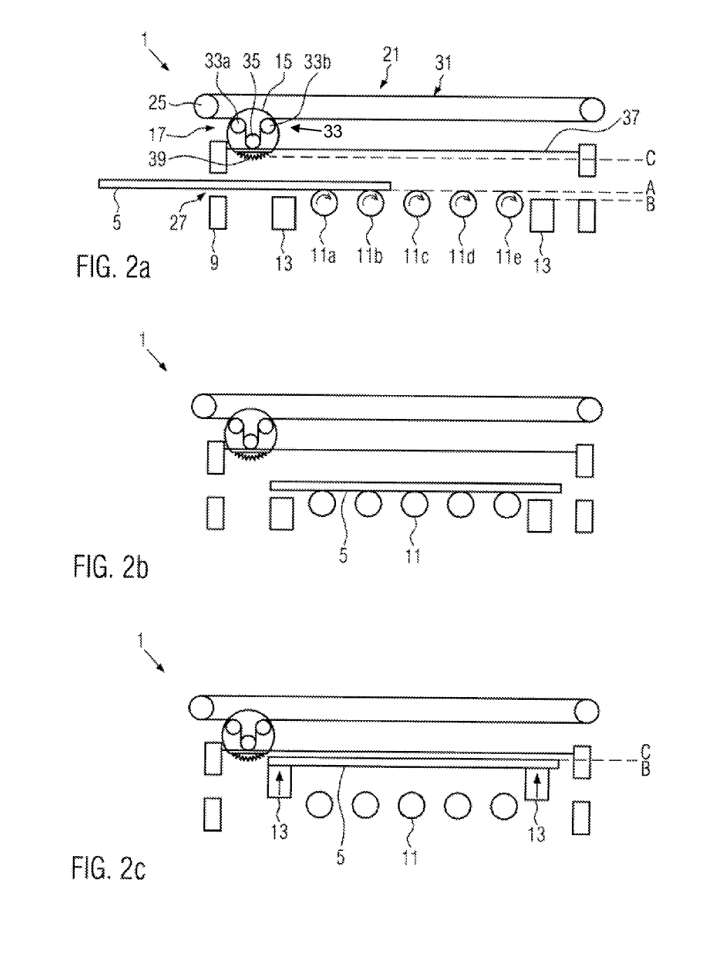

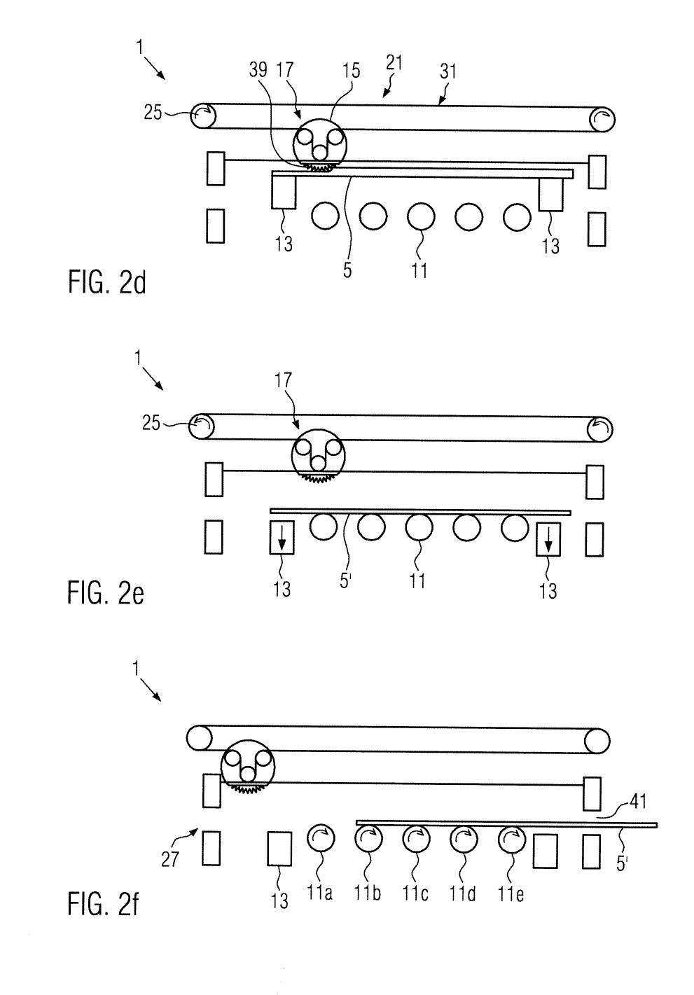

The use of the machine 1 and thereby one embodiment of the inventive method for creating grout lines on boards or for cutting boards into floor panels or tiles, in particular wall tiles or bathroom tiles, will be described in connection with FIGS. 2a to 2f. FIGS. 2a to 2f illustrate the machine 1 of the first embodiment in a schematic cross-sectional view. Features with the same reference numerals as already used in FIG. 1 correspond to the features of FIG. 1 and therefore their detailed description will be omitted, but is incorporated herewith by reference.

FIG. 2a illustrates a first step during which a board 5 is fed into machine 1 using the feeding means 11, here a plurality of rotating cylinders 11a-11e (the rotating direction of the cylinders is shown by arrows). Of course, it is not necessary that all of the cylinders 11a to 11e are actively driven. Board 5 enters the machine by the entrance slit 27 provided in the frame 9. As can be seen, the plane A defined by the feeding device, illustrated by broken lines, is positioned above plane B, defined by the upper surface of the support surface 13. Here the support surface 13 is realized as a frame, so that in the cross-sectional view only on the left and right side portions of the frame 13 are present. Of course, the frame could be realized differently, like for example with a grid form or with a plurality of parallel bars positioned between the rollers 11a to 11e.

The sawing device 17 is positioned above the feeding means 11 and the board 5. The linear drive 21 comprises a driving belt 31 which is driven by shaft 25, which in turn is driven by motor 23 (not shown). The circular saw 15 of the sawing device 17 is mount to a moveable carriage 33 which is driven by the linear drive 31 and which comprises, in this embodiment, two deflection pulleys 33a and 33b and one driving roller 35, the rotation of which leads to the movement of the carriage 33 on a guiding belt 37. The lower end of the sawing blade 39 defines the sawing plane C.

FIG. 2b shows the state in which board 5 has completely entered the machine 1 and the feeding means 11 stopped rotating so that board 5 now is in a stationary state. Next, as shown in FIG. 2c, the support surface 13 moves, pushed by the levering means 19 (not shown), upward and takes over board 5 from the feeding means 11. In this state the plane B of the board 5 and plane C characterizing the sawing plane, are coincident or at least close to each other such that the sawing blade 39 is capable of removing material from the board.

FIG. 2d then illustrates the actual sawing step during which, unlike the prior art, the sawing device 17 of machine 1 is moving over the board 5. To do so, like shown by the arrows on shaft 25, the belt 31 of the linear drive 21 is driven to thereby move the sawing device 17 via the driving roller 35. Here, due to the linear drive, the cut performed by the circular saw is linear and parallel to an edge of the board 5. Of course, depending on how the linear drive 31 is mount on frame 9, board 5 can also be cut under an angle with respect to the edge of board 5.

As can be seen in FIG. 2d, the sawing blade 39 is adjusted such that board 5 is not cut through, but that only a portion is removed from the board. With this arrangement grout lines are created on board 5 which in laminated products, imitating bathroom tiles, floor tiles or wall tiles, indicate the presence of grout. According to a variant (not shown) the saw 15 can also be arranged such that the sawing blade (or plate) 39 completely cuts through the board 5 to thereby cut board 5 into pieces to, in the end, create floor panels or tiles of a desired size. According to a further variant each saw 15 of the sawing device 17 can be adjusted individually such that in one run one saw creates grout lines, whereas another saw cuts completely through the board 5.

Eventually, according to a variant, the board 5 can be further pressed against the sawing device 17 to improve the fabrication tolerances by preventing vibrations. In this case the levering device 19, used for the take over between feeding device 11 and support surface 13, can be used again to push the substrate surface 13 further up, thereby pushing board 5 against the sawing device 17. This, however, represents only one possibility, having the advantage that the levering device 19 can be used as a displacement means and means for pressing the board against the sawing device at the same time. According to another variant, instead of pressing board 5 against the sawing device 17, an upper frame (not shown), against which board 5 is pressed, could be provided to fulfill the same function.

Once the board 5, in the following with the reference numeral 5′, has been treated with the sawing device 17, the supporting surface 13 lowers again, using the levering device 19, and places the treated board 5′ (in this case with the grout lines) again onto the feeding means 11. At the same time, in the embodiment, the sawing device 17 moves back to its initial position by changing the direction of rotation of shaft 25. Eventually this moving back to the initial position is omitted, in case the next board will be cut in the opposite direction.

FIG. 2f then illustrates the movement of board 5′ out of machine 1 using the feeding means 11a to 11e which are driven such that board 5′ leaves the machine on the side opposite to the entrance slit 27 via an exit slit 41 which is also provided in the frame 9 of the machine 1.

As already mentioned above, it is not obligatory that the board leaves the machine 1 via a different location. According to a variant, the board 5′ could leave the machine 1 via entrance slit 27.

According to a further variant, between the steps illustrated in FIG. 2b and the one illustrated in FIG. 2c or between the step illustrated in FIG. 2c and the one illustrated in FIG. 2d, a repositioning of the board 5 could take place in plane A or B, respectively, to correctly position board 5 with respect to the sawing device 17.

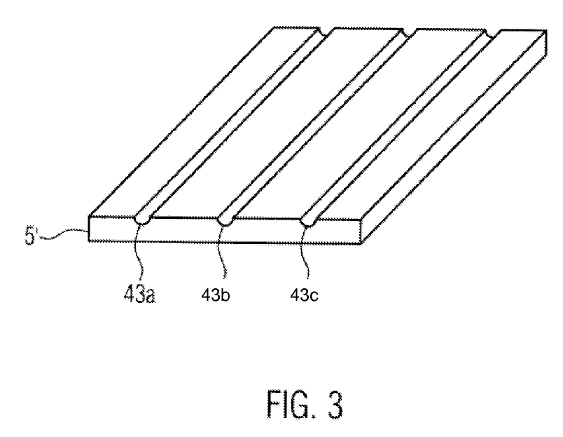

FIG. 3a illustrates one example of a board 5′ which has been treated in machine 1 according to the inventive method. Board 5′ is not cut into pieces by the sawing device 17, using the three circular saws 15, but presents three parallel grout lines 43a, 43b and 43c. Usually the depth of a grout line is of the order of 0.1 to about 1 mm.

To create a final product from board 5′, grout lines will be created in the direction perpendicular which can be achieved by turning board 5′ by 90° and introducing it in a machine like machine 1 so that the grout lines 43a, 43b and 43c are positioned perpendicular to the sawing blades 39 of the sawing device 17. Finally, board 5′ then has to be cut into the final size of the floor, wall or bathroom panels with a grout line structure on it. This is done by introducing board 5′ into a machine like the one illustrated in FIG. 1 and explained in combination with FIGS. 2a to 2f, wherein the sawing device is adjusted such that the sawing blades 39 cut the board into the correct size. Typically floor panels, wall panels or bathroom panels with a decorative laminate have sizes which usually go from about 75 mm to up to 600 mm. Eventually the cutting is done with the same machine by adjusting plane C of the sawing device 17 such that the cutting blade 39 cuts through board 5.

According to a second embodiment of the inventive machine for creating grout lines on panels and/or for cutting floor panels or tiles from panels, the displacement means is not like the levering device 19 configured to transfer a board from the feeding device 11 onto the support surface 13 and to raise it up to the sawing plane C, but is configured to lower the sawing device such that the sawing plane C becomes coincident with plane A or B. In this case the feeding means and the support surface could be integrated into one element. Apart form this difference the machine according to the second embodiment comprises the same features and characteristics as the machine according to the first embodiment. These features and characteristics are not repeated again in detail but are incorporated by reference.

Due to the fact that according to the invention it is the sawing device which moves over the board 5, the creation of scratches can be reduced compared to the sawing devices of the prior art. This is as on the side opposite to the sawing device, no relative movement occurs during the sawing step so that on the backside the risk for creating scratches, due to dust or chips, is greatly reduced. On the side where the sawing device 17 passes over the board 5 the risk for creation of scratches is also reduced which is due to a reduced contact surface between board 5 and the sawing device 17. In fact the contact surface preferably could be reduced to the interaction between the sawing blades and the board. Thus, with the present machine, improved floor panels and bathroom or wall tiles can be fabricated.

1. A machine for creating grout lines on boards or for cutting floor panels or tiles from boards comprising:
a feeder for moving a board into or out of the machine;
a sawing device comprising at least one circular saw; and,
a support surface for supporting the board, and wherein the sawing device is moveably arranged with respect to the support surface.

2. A machine according to claim 1, wherein the sawing device comprises two or more saws having their sawing blades arranged in parallel, and being provided on the moveable carriage.

3. A machine according to claim 1, further comprising a press for pressing a board against the sawing device.

4. A machine according to claim 1, further comprising an adjuster for positioning a board on the feeder or support relative to the at least one saw.

5. A machine according to claim 1, wherein the at least one saw is provided on a moveable carriage.

6. A machine according to claim 5, wherein the sawing device comprises two or more saws having their sawing blades arranged in parallel, and being provided on the moveable carriage.

7. A machine according to claim 6, further comprising a displacer configured to move a board from the feeder onto the support surface or from the support surface onto the feeder or configured to move the sawing device towards the support surface or the feeder.

8. A machine according to claim 7, further comprising a press for pressing a board against the sawing device.

9. A machine according to claim 8, wherein the displacer and the press are combined into one device.

10. A machine according to claim 9, further comprising adjuster for positioning a board on the feeder or support relative to the at least one saw.
